(19) United States
(12) Patent Application Publication
(10) Pub. No.: US 2019/0251304 A1
(43) Pub. Date: Aug. 15, 2019

(54) System for Detecting and Communicating the Presence of Tubing Insulating Disks

(71) Applicant: José Ramón Díaz Sanz, Castro Urdiales (ES)

(72) Inventor: José Ramón Díaz Sanz, Castro Urdiales (ES)

(21) Appl. No.: 16/332,960

(22) PCT Filed: Sep. 5, 2017
(86) PCT No.: PCT/ES2017/000109

§ 371 Date: Mar. 13, 2019

(30) Foreign Application Priority Data
Sep. 14, 2016 (ES) P/201600777

(51) Int. Cl. G06K 7/10

(52) U.S. Cl. CPC G06K 7/10

(57) ABSTRACT

An electronic system for detecting and communicating the presence of tubing insulating disks by radio frequency is provided herein. A flange where an insulating disk is to be placed is previously identified by means of a radio frequency identification card. The insulating disk carries an encapsulated group of electronic components attached thereto, for reading the card and emitting information by radio frequency. The card can only be read when the insulating disk is installed and the card is connected to the encapsulated group. Once the card has been read, a radio frequency signal is emitted, which will be captured by another, remote, receiving group. This is interpreted as the presence of the insulating disk. Extracting the card implies the interruption of the emission, which is interpreted as the absence of the insulating disk on the flange.

### TECHNICAL FIELD

The present invention relates to a passive security system for detecting and communicating the presence of tubing insulating disks by radio frequency. This system will enable knowing in real time the presence or absence of the insulating disk, streamlining the maintenance and repair processes in a secure environment in many industries, such as the chemical, food, pharmaceutics industries, etc.

### BACKGROUND OF THE INVENTION

To date there are wireless communication system which in conjunction with sensors for temperature, moisture, light etc. enable a receiver remote from the measuring point to obtain these values. Having consulted the reference businesses working in the field of these wireless communications, there are no systems similar to the one proposed.

### EXPLANATION OF THE INVENTION

The invention arises from devising a system for detecting and communicating the presence of tubing insulating disks in the petrochemical industry during repair or maintenance jobs. Currently, the insulation between sections of tubing is performed by inserting a round metal plate with reduced thickness between the connecting flanges which acts as a physical barrier for the passage of toxic, combustible, corrosive etc. fluids or gases. The method for executing these insulating jobs currently consists of:
1) A list for identifying and registering these blanking discs is carried out by the personnel usually in charge of the installations.
2) The flange or flanges are identified by the personnel who usually operates these installations, by means of placing cards or other means which enable the visual identification thereof, where this blanking disk must be introduced.
3) Then, workers specialised in boiler-making jobs insert the insulating disks.
4) The personnel who usually operates the installations confirms the correct installation of these insulating disks and lastly,
5) The personnel involved in this job sign the registration sheet.

This sheet thereby collects the signatures in the processes of placing or removing the insulating disks.

In order to streamline and provide greater security to this process, the idea arises of including an electronic system which enables knowing in real time the presence or absence of this insulating disk in an unequivocal manner. This system will be able to be installed in a multitude of these insulating disks, enabling the presence and identification of each one of them to be known simultaneously, such that the process is as follows:
1) The flange, where the insulating disk must be installed, is identified in a manner similar to the one explained previously. In this case, in the identification of the flange, where the insulating disk must be inserted, a small radio frequency identification card is included. The card to be used will be read-only. It will be a passive card, that is, it does not require any external electrical power source such that it is only activated when a reader is nearby to supply the energy necessary. This card is an electronic device comprised of an antenna, a radio transducer and a chip. This chip has an internal memory with variable capacity which contains the previously inserted identification information. This card must be inserted by means of any type of mechanical device as close as possible to the flange in which the insulating disk must be inserted. These cards can have anticollision, meaning, that the reading system is able to read several cards simultaneously. Likewise, these cards will be able to be identified by means of QR (Quick Response) codes and/or numbers.
2) The boilermaking personnel will insert the insulating disk in the previously identified flange. In this case, the insulating disk carries, attached and encapsulated, a compact and autonomous electronic system which will enable the reading of the information of the previously installed card and the emission by radio frequency of a signal containing the information read. This electronic system will be made up of a battery for powering the assembly, a radio frequency identification reader, a microprocessor and a transceiver (emitter) which will enable a radio frequency signal to be emitted, thereby indicating the presence of the blanking disk, LED diodes of different colours will also be able to be inserted which would be able to light up at a certain and configured time. Similarly, the removal of the disk will imply the interruption of the emission of this signal.
The encapsulated group, attached to the insulating disk, will have a housing or support system for the previously installed radio frequency emission card. The emission of the signal will be performed only when the reader detects the presence of the card. Given that the distance at which this system is capable of performing the reading is just a few centimetres, the reading will only be performed when the card is inserted in the housing of the encapsulated group present in the insulating disk and when it is installed between the flanges.
3) The receiver of the signals will be located at a control point; another microprocessor together with a transceiver which, connected to a computer, will enable the treatment of the identification signals. These signals will be able to be configured, from the coded identification itself, the date and time, the identification of the person who placed the insulating disk, etc. The communication between the control centre and the encapsulated group placed in the insulating disk will be able to be bidirectional.

### BRIEF DESCRIPTION OF THE DRAWINGS

As a complement to the description provided herein, and for the purpose of helping to make the characteristics of the invention more readily understandable, illustrations are attached as an integral part of said description, which, by way of illustration and not limitation represent the following:

FIG. 1 shows a flanged connection between tubes. On the left of the figure, it shows the flanged connection in profile between two tubing sections. In the centre of the figure, it shows one of the tubing sections in a view perpendicular to the generatrix thereof. On the right of the figure, it shows a perspective view of one of the tubing sections.

FIG. 2 shows the insulating disk which is inserted between the tubing sections. On the left of the figure, it shows the position in which the insulating disk is arranged between the tubing sections. In the centre, the insulating disk is represented seen from the front. On the right of the figure, it shows a perspective view of the insulating disk.

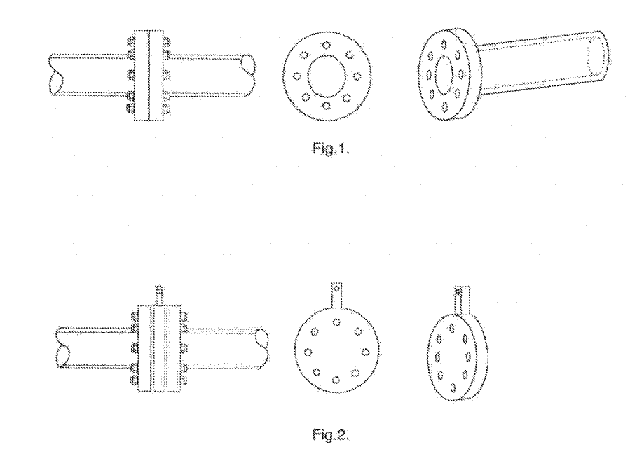

As can be seen, the upper portion of the insulating disk shows an appendage, usually used to handle the disk and which will be useful for the installation of the encapsulated group.

### PREFERRED EMBODIMENT OF THE INVENTION

From among the different types of radio frequency identification cards and readers, the one which only enables reading at a reduced distance will be chosen, such that the signalling of the presence or absence of the insulating disk will depend on the close contact between the card and the reader thereof. Therefore, the group of the invention can be divided into two portions, one of these being the radio frequency identification card itself which will be installed by means of flanges or other mechanical means as close as possible to the flange in which the insulating disk will be inserted. And moreover, the group: microprocessor, card reader, transceiver, antenna and a battery. This latter group will be arranged encapsulated and adhered to the insulating disk, in the appendage it has, and as seen in FIG. 2. This encapsulated group will need to have some type of slot or support in order to maintain the contact with the card while the insulating disk is present. The microprocessor will be programmed beforehand so that when the presence of the card is detected, it sends a radio frequency signal which will need to be captured from the control point. This signal will be able to be configurable. The radio frequency identification cards can be rewritten in order to include different information.

When the insulating disk is removed, it ends the contact between card and reader, interrupting the communication and indicating that the insulating disk is not present anymore. The installation or removal of these insulating disks is performed by means of prior authorisation. For this reason, the interruption of the signal of an insulating disk without authorisation will need to be confirmed.

The use of this system for detecting and communicating the presence of insulating disks will enable the presence of infinite insulating disks to be known at all times and simultaneously.

A subsequent development would enable an interface to be programmed which is suitable for the visualisation thereof on an implementation plan in a computer. Or rather, by means of the insertion of coloured LED diodes in an encapsulated group to know when the removal of an insulating disk is authorised or not.

1. A system for detecting and communicating the presence of a tubing insulating disk by means of a communication system by radio frequency, the system comprising:
a battery configured to power the group, a transponder configured to read radio frequency identification cards, a microprocessor and a transceiver including an antenna configured to emit radio frequency waves; wherein the encapsulated group is connected to the insulating disk;
a radio frequency identification card configured to identify a flange in which the insulating disk must be inserted, the radio frequency identification card comprising: an antenna, a chip, and a radio transducer, wherein the radio frequency identification card is installed near the flange in question; and
a receiver element or control centre comprising; a transceiver, and a microprocessor connected to a computer, configured to treat radio frequency signals in a remote control point;
wherein the transponder of the encapsulated group configured to read the radio frequency identification card when the insulating disk is installed between flanges of tubing sections to be insulated and the radio frequency identification card is close to the radio frequency identification reader, and a radio frequency signal certifies the presence of the insulating disk between the tubing sections to be insulated start emit.

2. The system according to claim 1, wherein the encapsulated group of electronic components further comprises at least one housing or at least one support configured to house radio frequency identification cards, and the radio frequency signal which certifies the presence of the insulating disk will be emitted only when the insulating disk is installed and the radio frequency identification card is placed in the housing; wherein extracting the radio frequency identification card interrupts the emission of the radio frequency signal, and is interpreted as an absence of the insulating disk in the flange in question; and wherein different jobs can require the presence of one and the same insulating disk for which reason in order to prevent the undue removal of this insulating disk, each job need to have its own radio frequency identification card.

3. The system according to claim 1, wherein the radio frequency identification cards are anti-collision, thereby enabling the radio frequency identification card reader to detect and read the information of several cards simultaneously.

4. The system according to claim 1, wherein the radio frequency identification cards are passive and configured to read information inserted in a memory chip without electrical power.

5. The system according to claim 1, wherein the radio frequency identification cards are identified numerically and further comprise a sticker, the sticker including a QR (quick response) code configured for visual and electronic identification.

6. The system according to claim 1, wherein a communication between the encapsulated group and the control centre is bidirectional.

7. The system according to claim 6, wherein the encapsulated group further comprises a plurality of LED diodes of different colours and, a colour code indicates the presence or absence of the insulating disk, and wherein a variation of colours is communicated between the control centre and encapsulated group.
